(19) United States
(12) Patent Application Publication
(10) Pub. No.: US 2016/0301629 A1
(43) Pub. Date: Oct. 13, 2016

(54) CONTROL DEVICE, NETWORK SYSTEM, PACKET TRANSFER CONTROL METHOD, AND PROGRAM FOR CONTROL DEVICE

(71) Applicant: NEC CORPORATION, Tokyo (JP)

(72) Inventor: Kazuya SUZUKI, Tokyo (JP)

(21) Appl. No.: 14/911,334

(22) PCT Filed: Aug. 28, 2014
(86) PCT No.: PCT/JP2014/004429

§ 371 Date: Feb. 10, 2016

(30) Foreign Application Priority Data
Sep. 26, 2013 (JP) 2013-199255

(51) Int. Cl. H04L 12/947; H04L 12/855

(52) U.S. Cl. CPC H04L 49/25; H04L 47/2466

(57) ABSTRACT

To achieve a transmission of a control message to a device provided separately from a control device without increasing load on the control device which controls a transfer device. A control device 90 controls a packet transferring operation of a plurality of transfer devices to transfer a packet. The control device 90 includes a transfer-rule-for-control generation element 91. The transfer-rule-for-control generation element 91 generates a transfer rule for control which defines an operation for a transfer device to transfer, between a router and a route information collection device, a control message to notify a route information collection device of route information indicating a route used when a router transmits a packet to another router via a transfer device.

### TECHNICAL FIELD

The present invention relates to a control device which controls a transfer device by transmitting a transfer rule to the transfer device which transmits a packet according the transfer rule, a network system including the control device, and a packet transfer control method and a program for a control device which are applied to the control device.

### BACKGROUND ART

As a protocol in which a control device controls a switch to transfer a packet, the

OpenFlow has been known. A switch in the OpenFlow is referred to as an OpenFlow switch (OFS). A control device in the OpenFlow is referred to as an OpenFlow controller (OFC). The OFS and the OFC are disclosed in, for example, Non Patent Literatures 1 and 2. Hereinafter, the outlines of the OFS and the OFC in the OpenFlow 1.0 defined in Non Patent Literature 2 will be described.

The OFS and the OFC communicate with each other via a communication channel called as a secure channel. The OFS includes a flow table referred to transfer a packet. The flow table contains a flow entry, in which a transfer destination of a packet is determined corresponding to a flow. The OFC communicates, according to the OpenFlow, with the OFS via the secure channel and controls the flow at an application program interface (API) level.

Hereinafter, an example of the control of the OFC to the OFS will be described. When receiving a packet, the OFS searches for the flow entry matching the packet. When there is no flow entry matching the packet, the OFS transfers the packet to the OFC via the secure channel. The packet which does not match any flow entry is called as a first packet. The OFC holds topology information on the network of the OFS. Then, when receiving the packet from the OFS, the OFC determines the path of the packet based on information on the destination and the transmission source of the packet, and the topology information. Furthermore, the OFC determines the flow entry for each OFS on the path and sets the flow entry for each OFS on the path. The first packet which the OFS receives is sequentially transferred, according to the flow entry, to the next OFS along the determined path. The second and following packets are sequentially transferred to the next OFS along the path.

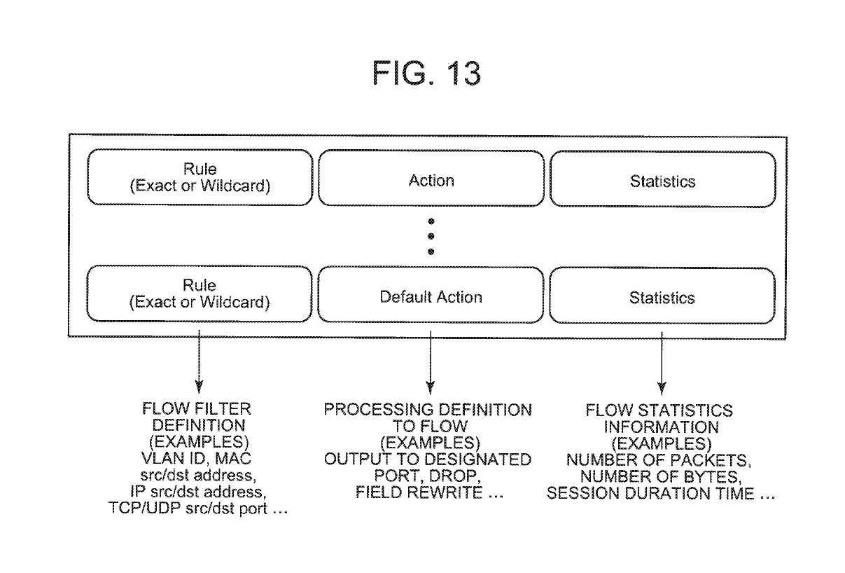

FIG. 13 is an explanatory diagram illustrating an example of a flow entry in a flow table. The flow entry is determined for each flow. The flow entry includes a rule to be collated with a packet header, an action defined with processing to the flow, and flow statistics information (statistics). The rule o be collated with a packet header may be an exact value or a wildcard. The action is applied to the packed matching the rule. The flow statistics information is also called as an activity counter. The flow statistics information includes, for example, the number of active entries, the number of lookup packets, and the number of matching packets. Furthermore, the flow statistics information includes, for example, a period during the number of received packets, the number of received bytes, and the flow are active in a flow unit. Moreover, the flow statistics information includes, for example, the number of received packets, the number of transmitted packets, the number of received bytes, the number of transmitted bytes, the number of received drops, the number of reception errors, the number of transmission errors, the number of reception frame alignment errors, the number of reception overrun errors, the number of reception cyclic redundancy check (CRC) errors, and the number of collisions in a port unit.

When receiving a packet, the OFS collates the packet with rules of flow entries in the flow table. When there is no flow entry matching the packet, the OFS handles the packet as a first packet and transmits the packet to the OFC via the secure channel The OFS adds, changes, and erases the flow entry to the flow entry which the OFS has.

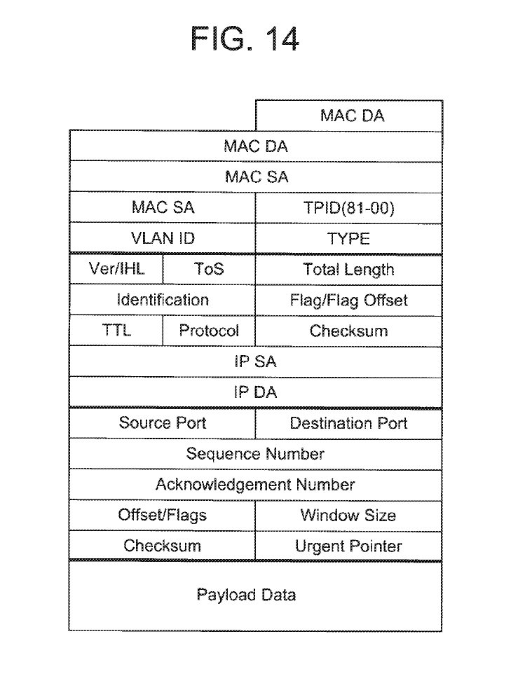

FIG. 14 is a schematic diagram illustrating a packet header. “DA” means a destination address. “SA” means a source address. To collates the packet with the rule in the flow entry, the OFS uses, for example, a media access control (MAC) DA, a MAC SA, an Ethernet (registered trademark) type (TPID), a virtual local area network identification (VLAN ID), a VLAN TYPE (priority), an internet protocol SA (IP SA), an IP DA, an IP protocol, a source port (a TCP/UDP source port or an internet control message protocol (ICMP) type), and a destination port (a TCP/UDP destination port or an ICMP code) in the packet header (see FIG. 14).

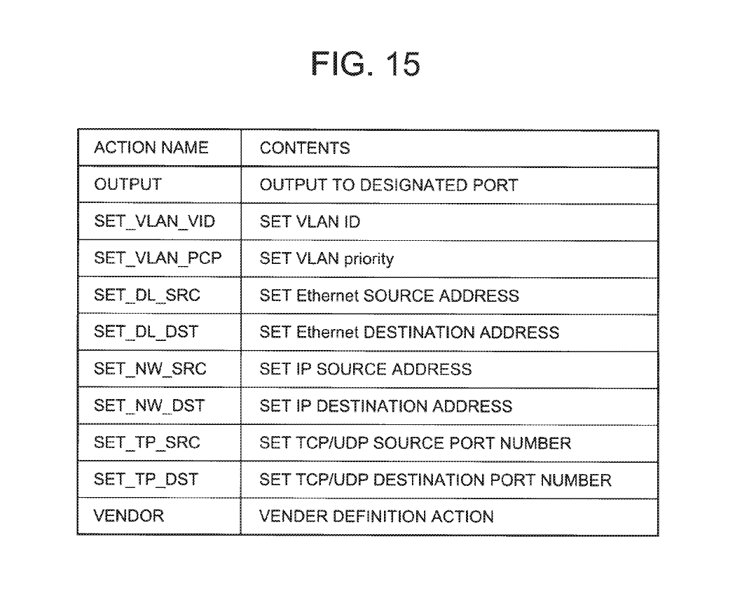

FIG. 15 is an explanatory diagram illustrating examples of action names and action contents. “OUTPUT” means that a packet is output to a designated port (interface). The actions from “SET_VLAN_VID” to “SET_TP_DST” each are an action to correct a field in the packet header.

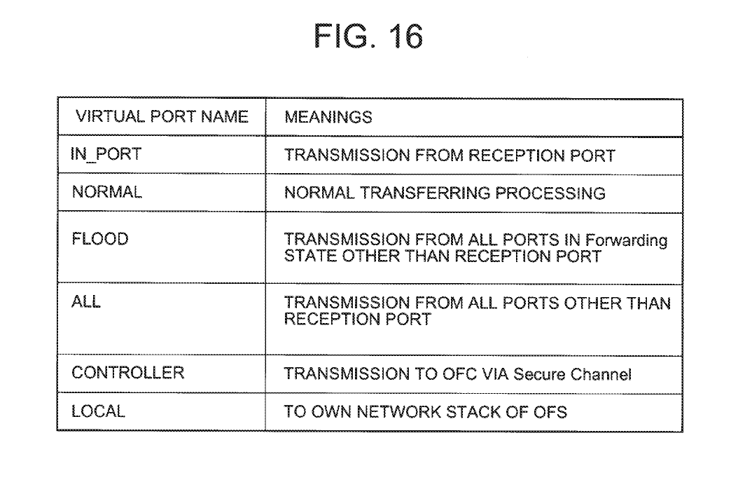

Furthermore, the OFS outputs a packet from a physical port, or virtual ports described below. FIG. 16 is an explanatory diagram illustrating examples of the virtual ports. “IN_PORT” means that the packet is transmitted from an input port. “NORMAL” means that the packet is processed using an existing transfer path supported by the OFS. “FLOOD” means that the packet is transmitted from all of the ports in a communicable state (forwarding state) other than the port which has received the packet. “ALL” means that the packet is transmitted from all of the ports other than the port which has received the packet. “CONTROLLER” means that the packet is encapsulated and transmitted to the OFC. “LOCAL” means that the packet is transmitted to the own network stack of the OFS. The packet matching the flow entry which is not designated with an action is dropped (discarded).

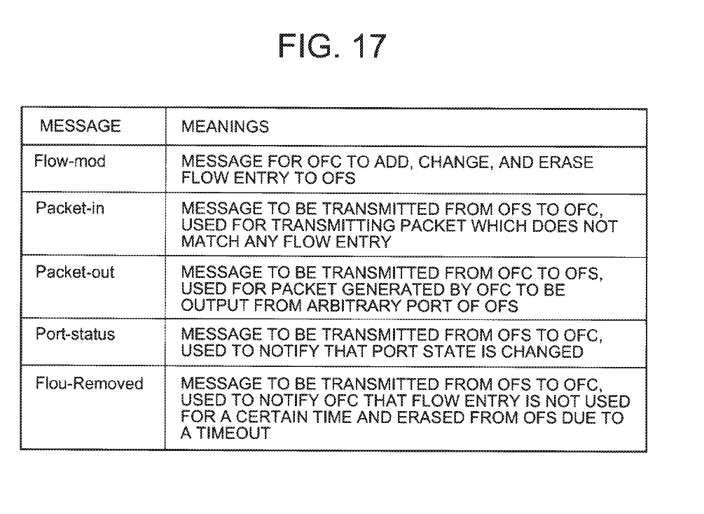

FIG. 17 is an explanatory diagram illustrating examples of messages to be exchanged via the secure channel “Flow-mod” is a message for the OFC to add, change, and erase the flow entry to the OFS. “Packet-in” is a message to be transmitted from the OFS to the OFC. “Packet-in” is used for the packet which does not match any flow entry to be transmitted to the OFC. “Packet-out” is a message to be transmitted from the OFC to the OFS. “Packet-out” is used for the packet generated by the OFC to be output from an arbitrary port of the OFS. “Port-status” is a message to be transmitted from the OFS to the OFC. “Port-status” is used to notify that the port state is changed. For example, when a failure occurs in the link connected with the port, “Port-status” is used to notify the OFC that the port state becomes a link down state. “Flow-Removed” is a message to be transmitted from the OFS to the OFC. “Flow-Removed” is used to notify the OFC that the flow entry is not used for a certain time and erased from the OFS due to a timeout.

The outlines of the OFS and the OFC in the OpenFlow 1.0 has been described above.

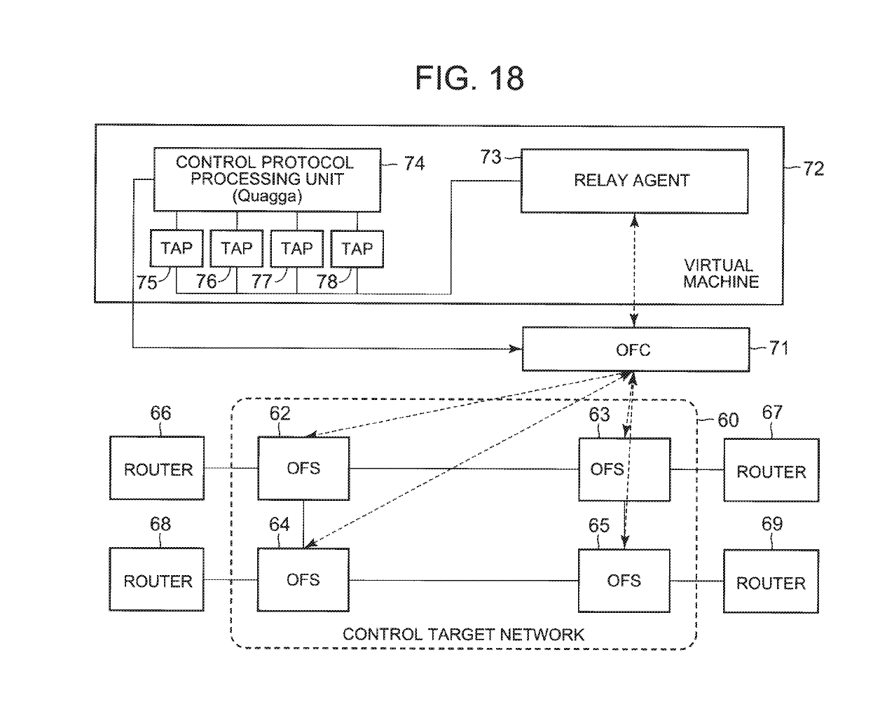

In Non Patent Literature 3, an implementation of an OFC for a network constituted of OFSs to operate as an IP network is proposed. FIG. 18 is a schematic diagram illustrating a configuration example proposed in Non Patent Literature 3. In the example illustrated in FIG. 18, OFSs 62 to 65 are included in a control target network 60. Furthermore, routers 66 to 69 are connected with the OFSs 62 to 65 respectively as illustrated in FIG. 18. To emulate the IP network, a control protocol processing unit 74 having a function of a route control protocol, such as an open shortest path first (OSPF), needs to be provided. A flow entry is generated for each destination IP address based on route information collected by the route control protocol, and set for each of the OFSs 62 to 65. In the QuagFlow, a virtual machine 72 having a function of the route control protocol is provided separately from an OFC 71 and cooperates with the OFC 71, and the function is implemented accordingly. The virtual machine 72 includes a control protocol processing unit 74 which operates according to the Quagga which is route control software published in an open source. The OFC 71 transmits a message of the route control protocol received at the OFS side is transmitted to a relay agent 73 which operates in the virtual machine 72. Then, the control message is transmitted to the control protocol processing unit 74 through TAP interfaces 75 to 78. Viewing from the Quagga, this is the same environment in which Linux (registered trademark) operates as a router. Thus, the Quagga can be used without being modified.

Furthermore, Patent Literature 1 discloses a system in which a packet received by a relay device is transmitted to a control device. In the system disclosed in Patent Literature 1, the control device uses a symbol associated with address information on a relay device to determine which interface has received the packet transmitted from the relay device. As the relay device disclosed in Patent Literature 1, a device to which an address for each interface is assigned, such as a router, can be used.

### CITATION LIST

### Patent Literature

PTL 1: Japanese Patent Application Laid-Open No.2004-320694

### Non Patent Literatures

NPL 1: Nick Mckeown, and seven others, “OpenFlow: Enabling Innovation in Campus Networks”, Mar. 14, 2008, [searched on Sep. 11, 2013], internet <http://www.openflowswitch.org//documents/openflow-wp-latest.pdf>

NPL 2: “OpenFlow Switch Specification Version 1.0.0 (Wire Protocol 0x01)”, Dec. 31, 2009, [searched on Sep. 11, 2013], internet <http://www.openflow.org/documents/openflow-spec-v1.0.0.pdf>

NPL 3: Marcelo Ribeiro Nascimento, and three others, “QuagFlow: Partnering Quagga with OpenFlow”, [searched on Sep. 11, 2013], internet <http://conferences.sigcomm org/sigcomm/2010/papers/sigcomm/p441.pdf>

### SUMMARY OF INVENTION

### Technical Problem

In a configuration in which a control protocol processing device, which operates according to a route control protocol, collects route information and an OFC generates a flow entry using the route information, a control message (hereinafter, referred to as a route control message) needs to be transmitted to notify the control protocol processing device of the route information.

In the technique disclosed in Non Patent Literature 3, an OFS transmits the received route control message to the OFC 71 using a “Packet-in” message of the OpenFlow. The route control message is transmitted from the OFC 71 to the relay agent 73 prepared in the virtual machine 72, and transmitted to the control protocol processing unit 74 via a virtual interface (see FIG. 18). Thus, all of the route control messages to be transmitted to the control protocol processing unit 74 are relayed by the OFC 71, and the processing load on the OFC 71 is increased accordingly.

Furthermore, the technique disclosed in Patent Literature 1 is applied to the OpenFlow, the OFS can be used as a relay device. However, since an address for each interface is not assigned in the OFS, the OFS cannot be used as the relay device disclosed in Patent Literature 1. Moreover, in the technique disclosed in Patent Literature 1, the relay device is required to add a symbol to a packet when transmitting the packet to the control device. The packet length becomes longer or the packet processing load is increased accordingly.

Thus, a purpose of the present invention is to transmit the control message to a device provided separately from a control device without increasing a load on the control device which controls a transfer device.

### Solution to Problem

A control device of the present invention which controls a packet transferring operation of a plurality of transfer devices to transfer a packet, the control device includes: transfer-rule-for-control generation means for generating a transfer rule for control which defines an operation for the transfer device to transfer, between a router and a route information collection device, a control message to notify the route information collection device of route information indicating a route used when the router transmits the packet to another router via the transfer device.

Furthermore, a network system of the present invention includes: a plurality of transfer devices configured to transfer a packet; and a control device configured to control a packet transferring operation of the transfer devices, wherein the control device includes transfer-rule-for-control generation means for generating a transfer rule for control which defines an operation for the transfer device to transfer, between a router and a route information collection device, a control message to notify the route information collection device of route information indicating a route used when the router transmits the packet to another router via the transfer device.

Furthermore, a packet transfer control method of the present invention includes: generating, by a control device which controls a packet transferring operation of a plurality of transfer devices to transfer a packet, a transfer rule for control which defines an operation for the transfer device to transfer, between a router and a route information collection device, a control message to notify the route information collection device of route information indicating a route used when the router transmits the packet to another router via the transfer device.

Furthermore, a program for a control device of the present invention to be installed to a computer which controls a packet transferring operation of a plurality of transfer devices to transfer a packet, the program causes the computer to execute: transfer-rule-for-control generation processing to generate a transfer rule for control which defines an operation for the transfer device to transfer, between a router and a route information collection device, a control message to notify the route information collection device of route information indicating a route used when the router transmits the packet to another router via the transfer device.

### Advantageous Effects of Invention

According to the present invention, it is possible to transmit a control message to a device separately provided from a control device without increasing a load on the control device which controls a transfer device.

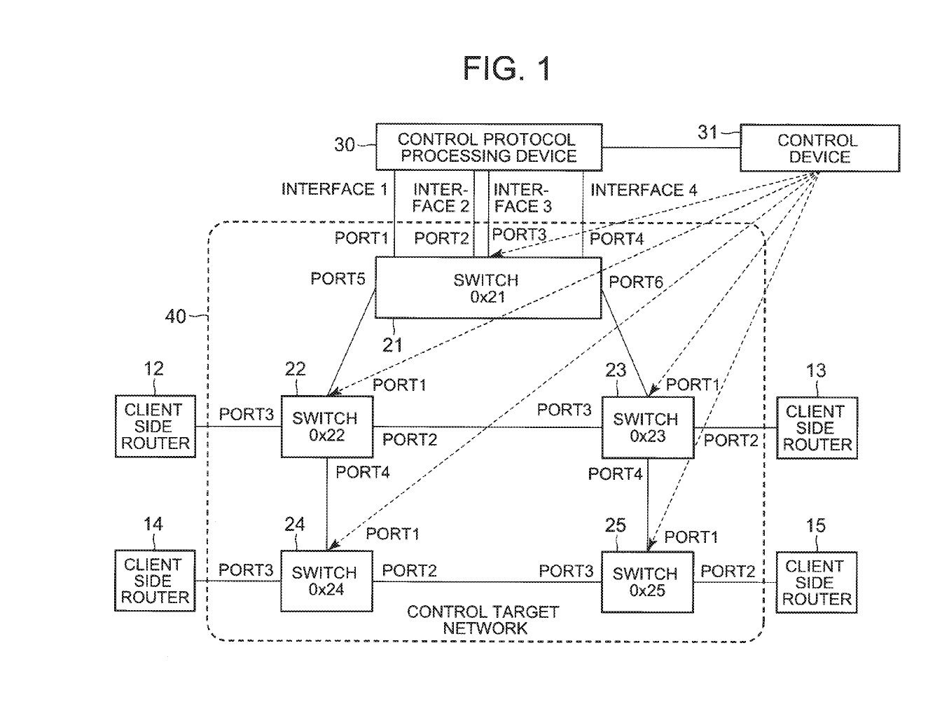

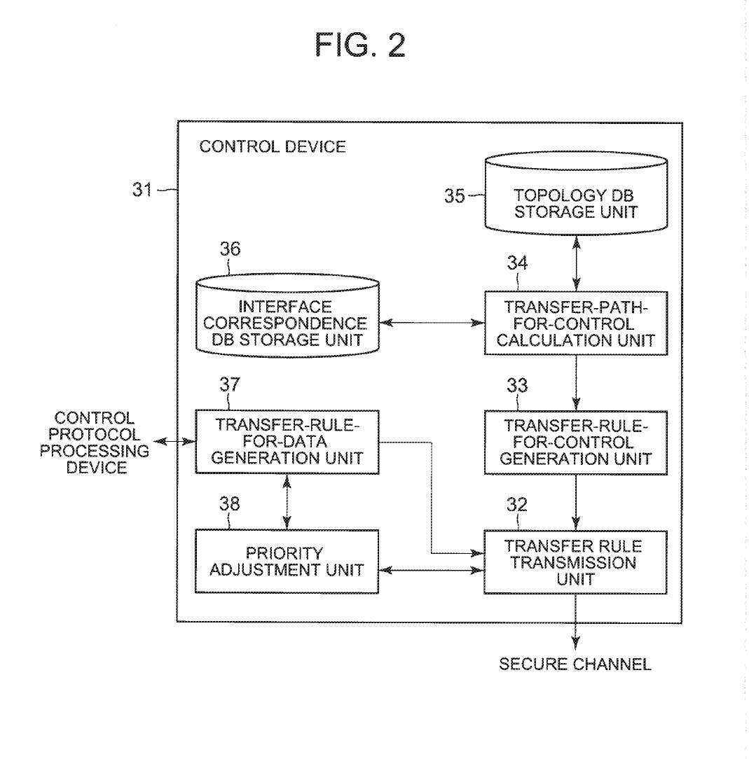

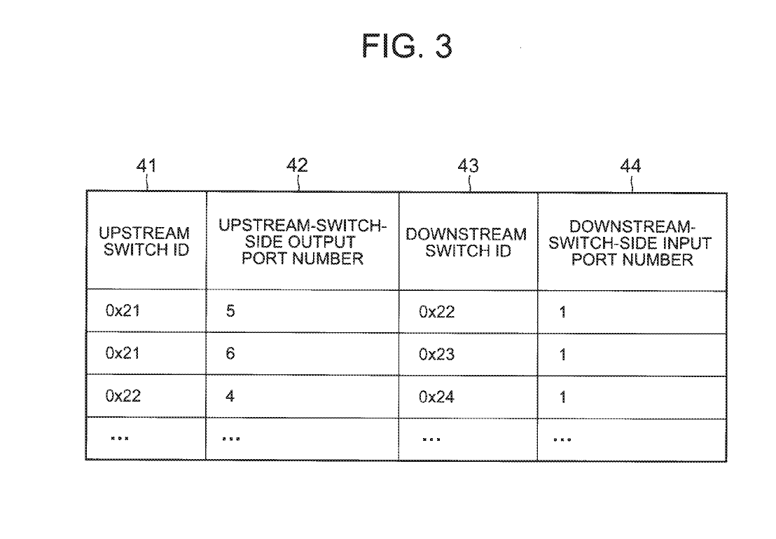

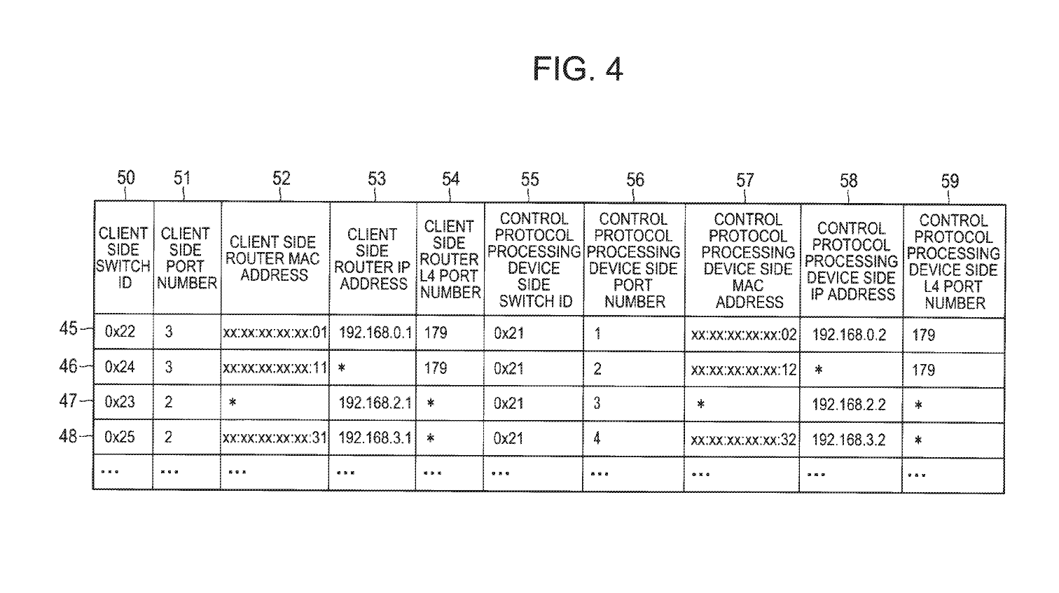

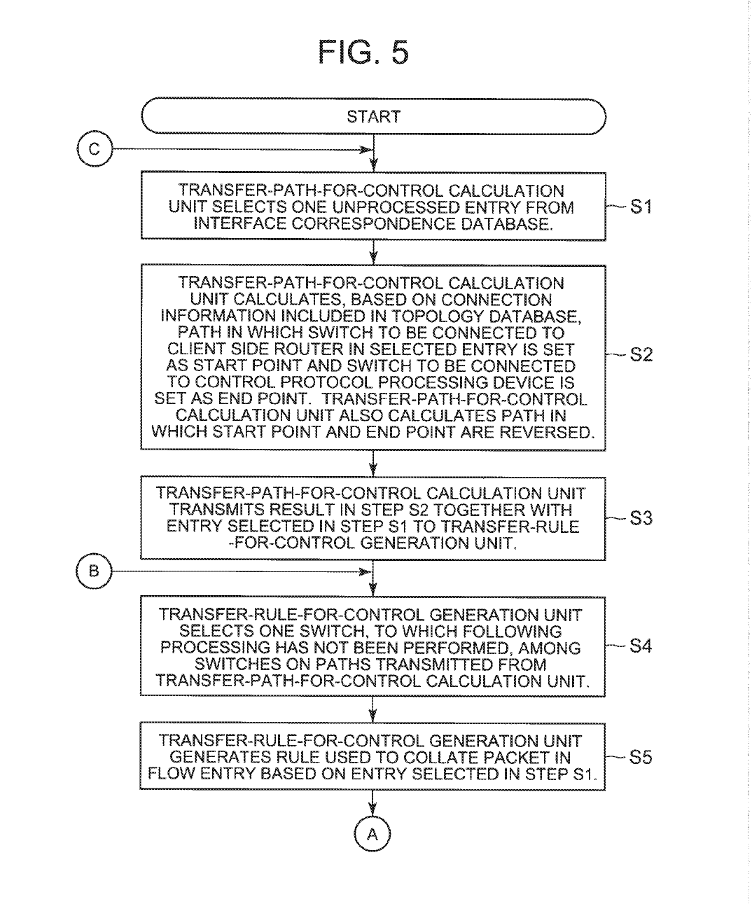

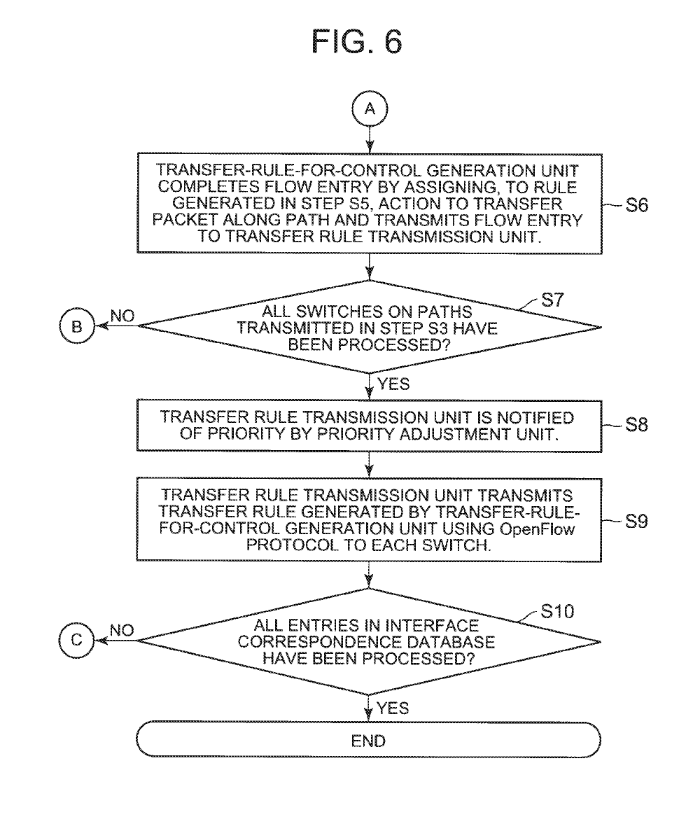

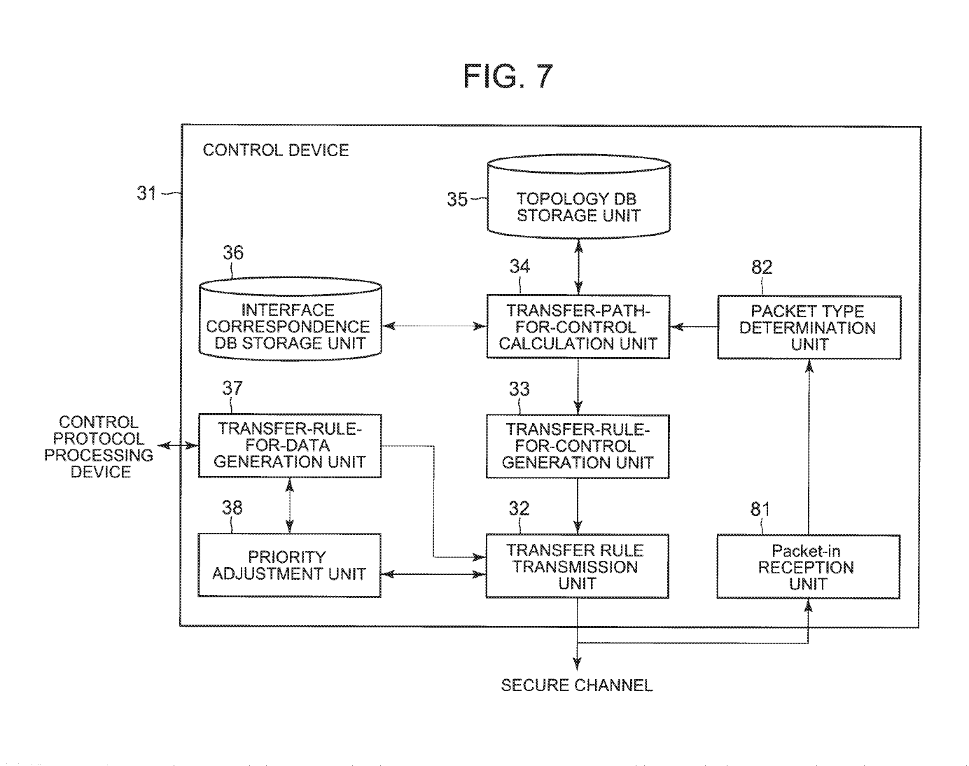

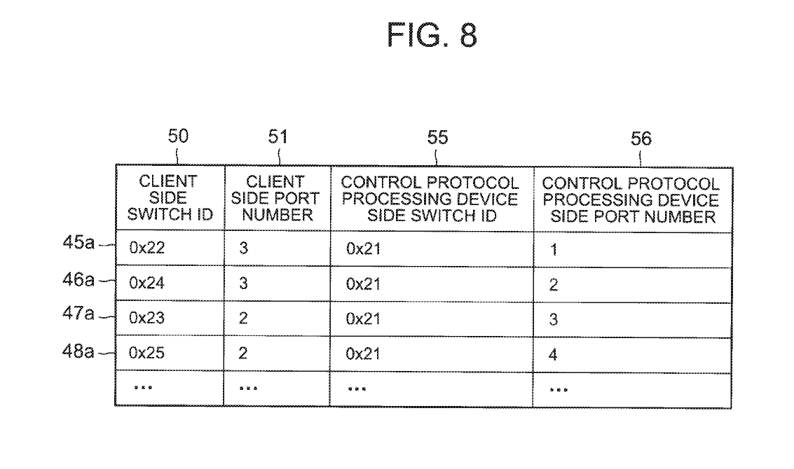

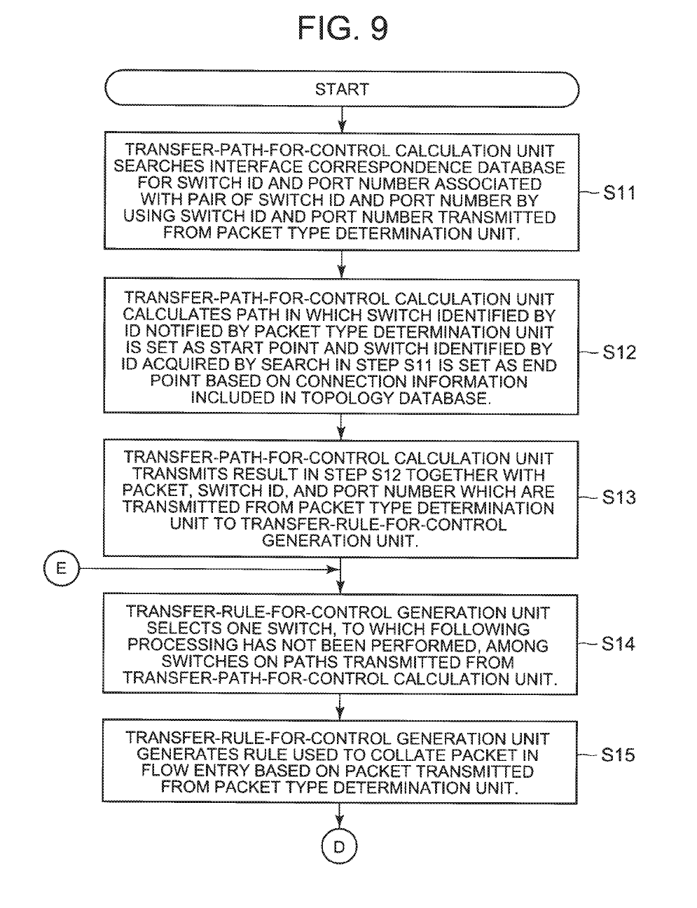

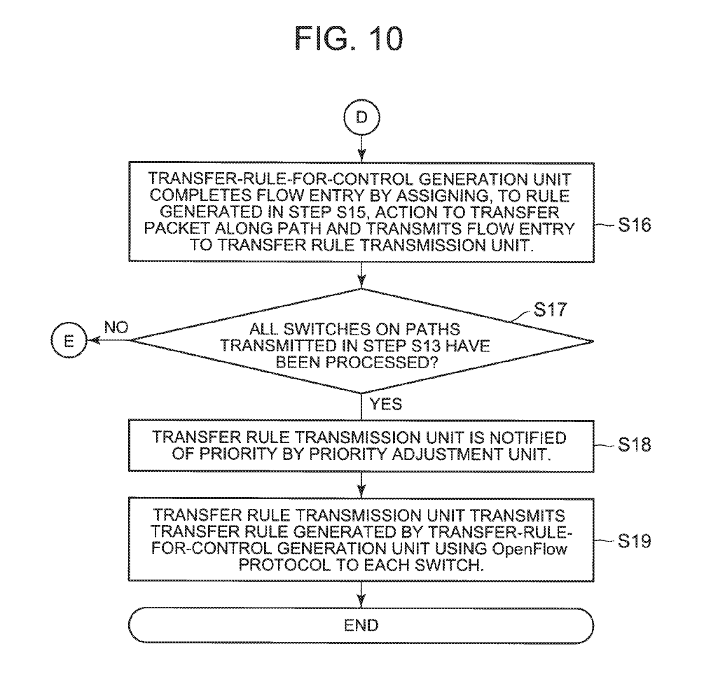

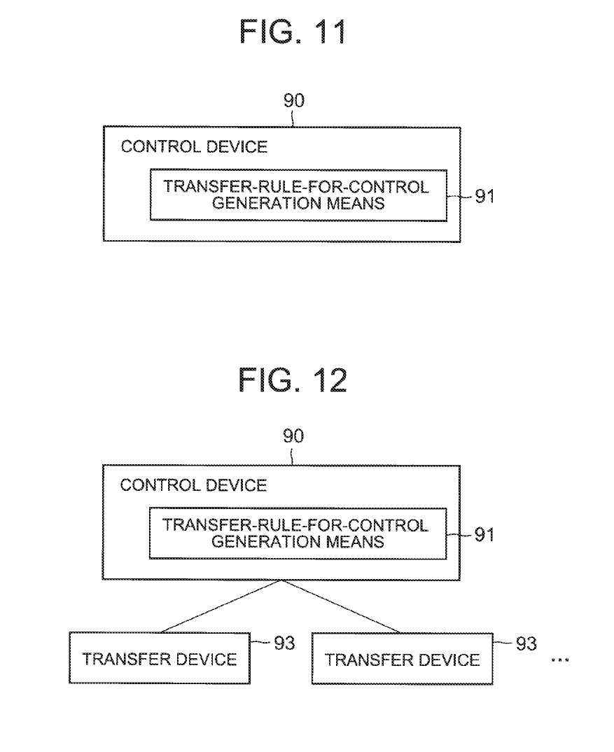

### BRIEF DESCRIPTION OF DRAWINGS

[FIG. 1] It depicts an explanatory diagram illustrating an example of a network system of the present invention.

[FIG. 2] It depicts a block diagram illustrating a configuration example of a control device in a first exemplary embodiment of the present invention.

[FIG. 3] It depicts an explanatory diagram illustrating an example of a topology DB.

[FIG. 4] It depicts an explanatory diagram illustrating an example of an interface correspondence DB.

[FIG. 5] It depicts a flowchart illustrating an example of processing progress when the control device sets a transfer rule for control to a switch.

[FIG. 6] It depicts a flowchart illustrating an example of the processing progress when the control device sets a transfer rule for control to a switch.

[FIG. 7] It depicts a block diagram illustrating a configuration example of a control device in a second exemplary embodiment of the present invention.

[FIG. 8] It depicts an explanatory diagram illustrating an example of an interface correspondence DB in the second exemplary embodiment.

[FIG. 9] It depicts a flowchart illustrating an example of processing progress when the control device sets a transfer rule for control to a switch in the second exemplary embodiment.

[FIG. 10] It depicts a flowchart illustrating an example of the processing progress when control device sets a transfer rule for control to a switch in the second exemplary embodiment.

[FIG. 11] It depicts a block diagram illustrating an outline of a control device of the present invention.

[FIG. 12] It depicts a block diagram illustrating an outline of a network system of the present invention.

[FIG. 13] It depicts an explanatory diagram illustrating an example of a flow entry in a flow table.

[FIG. 14] It depicts a schematic diagram illustrating a packet header.

[FIG. 15] It depicts an explanatory diagram illustrating examples of action names and action contents.

[FIG. 16] It depicts an explanatory diagram illustrating examples of virtual ports.

[FIG. 17] It depicts an explanatory diagram illustrating examples of messages exchanged via a secure channel.

[FIG. 18] It depicts a schematic diagram illustrating a configuration example proposed in Non Patent Literature 3.

### DESCRIPTION OF EMBODIMENTS

Hereinafter, an exemplary embodiment of the present invention will be described with reference to the drawings.

### First Exemplary Embodiment

FIG. 1 is an explanatory diagram illustrating an example of a network system of the present invention. The network system of the present invention includes a control device 31, a control protocol processing device 30, and switched 21 to 25. The switches 21 to 25 forms a control target network 40. In FIG. 1, although five switches are illustrated, the number of switches which form the control target network 40 is not limited. In FIG. 1, “0x22” and the like are switch IDs. Furthermore, a person who transmits data using the control target network 40 (here, referred to as a client) has routers 12 to 15. Hereinafter, the routers 12 to 15 are referred to as client side routers. The number of client side routers is not limited. The client side routers 12 to 15 each hold route information indicating a route in the control target network 40 (a route between the client side routers) used when data (a packet) is to be transmitted via the control target network 40.

The control device 31 is connected with the individual switches 21 to 25 via a secure channel In the example illustrated in FIG. 1, the secure channels are indicated as dashed lines. The secure channel is provided separately from a route to transmit and receives a packet between the client side routers. Then, the control device 31 controls the switches 21 to 25 using the OpenFlow.

The packet to be transferred using the switches 21 to 25 forming the control target network 40 as nodes includes a packed to be transmitted and received between the client side routers and a route control message to notify the control protocol processing device 30 of the route information held by the client side router.

The control protocol processing device 30 collects the route information on the packed to be transmitted and received between the client side routers by transmitting and receiving the route control message between the client side routers 12 to 15 according to a control protocol to acquire the route information. Here, the control device 31 determines a transfer route of the route control message between the individual client side routers 12 to 15 and the control protocol processing device 30. Then, the control device 31 determines a transfer rule to transfer the route control message to the next node (hereinafter, referred to as a transfer rule for control) for each switch on the transfer route, and sets the transfer rule for control for each switch on the transfer route. Thus, it is possible to transmit and receive the route control message between the individual client side routers 12 to 15 and the control protocol processing device 30 accordingly.

The control protocol processing device 30 notifies the control device 31 of the route information collected from the client side routers 12 to 15. The control device 31 determines, based on the route information, a transfer rule to transfer the packet to the next node (hereinafter, referred to as a transfer rule for data) for each switch on the transfer route of the packet to be exchanged between the client side routers, and sets the transfer rule for data for each switch on the transfer route. Thus, it is possible to transmit and receive the packet between the client side routers.

Furthermore, both of the transfer rule for control and the transfer rule for data are the flow entry.

FIG. 2 is a block diagram illustrating a configuration example of the control device in the first exemplary embodiment of the present invention. The control device 31 in the first exemplary embodiment includes a transfer rule transmission unit 32, a transfer-rule-for-control generation unit 33, a transfer-path-for-control calculation unit 34, a topology database (hereinafter, referred to as a topology DB) storage unit 35, an interface correspondence database (hereinafter, referred to as an interface correspondence DB) storage unit 36, a transfer-rule-for-data generation unit 37, and a priority adjustment unit 38.

The topology DB storage unit 35 is a storage device which stores a topology DB. The topology DB is a collection of connection information between the individual switches in the control target network 40 controlled by the control device 31. The topology DB is stored in the topology DB storage unit 35 in advance. A method for collecting and storing the topology DB in the topology DB storage unit 35 is not particularly limited. FIG. 3 is an explanatory diagram illustrating an example of the topology DB. The topology DB has a plurality of entries including an upstream switch ID 41, an upstream-switch-side output port number 42, a downstream switch ID 43, and a downstream-switch-side input port number 44. With one entry, the port of the switch as the upstream end of the link and the port of the switch as the downstream end of the link are identified. For example, the first entry illustrated in FIG. 3 indicates that there is a link from a fifth port of the switch whose ID is “0x21” to a first port of the switch whose ID is “0x22”.

The interface correspondence DB storage unit 36 is a storage device which stores an interface correspondence DB. The interface correspondence DB is a collection of information indicating the correspondence relation between a client side router and an interface of the control protocol processing device 30. A method for collecting and storing the interface correspondence DB in the interface correspondence DB storage unit 36 is not particularly limited. For example, the interface correspondence DB may be manually created and stored in the interface correspondence DB storage unit 36.

FIG. 4 is an explanatory diagram illustrating an example of the interface correspondence DB. The interface correspondence DB has a plurality of entries including ten items of an ID 50 of a switch to be connected to a client side router, a port number 51 of a port to be connected to the client side router at the switch, a MAC address 52 of the client side router, an IP address 53 of the client side router, a layer 4 (L4) port number 54 of the client side router, an ID 55 of a switch to be connected to the control protocol processing device 30, a port number 56 of a port to be connected to the control protocol processing device 30 at the switch, a MAC address 57 of an interface of the control protocol processing device 30, an IP address 58 of the interface of the control protocol processing device 30, and an L4 port number 59 of the interface of the control protocol processing device 30.

One entry in the interface correspondence DB corresponds to one client side router. For example, a first entry 45 illustrated in FIG. 4 indicates the correspondence relation between the client side router 12 and the control protocol processing device 30. Specifically, the first entry 45 illustrated in FIG. 4 indicates that the ID of the switch to be connected to the client side router is “0x22”, and the client side router is to be connected to a third port of the switch. The client side router 12 connected with the third port of the switch whose ID is “0x22” (see FIG. 1) is the client side router in the entry 45. Furthermore, the entry 45 indicates that the MAC address and the IP address of the client side router 12 are “xx:xx:xx:xx:xx:01” and “192.168.0.1” respectively. The entry 45 also indicates that the ID of the switch to be connected to the control protocol processing device 30 is “0x21”, and the control protocol processing device 30 is to be connected to the first port of the switch. Thus, it is known that the interface 1 of the control protocol processing device 30 to be connected to the first port of the switch whose ID is “0x21” (see FIG. 1) corresponds to the client side router 12. The entry 45 further indicates that the MAC address and the IP address of the interface 1 of the control protocol processing device 30 are “xx:xx:xx:xx:xx:02” and “192.168.0.2” respectively. Furthermore, in the entry 45, both of the L4 port number of the client side router 12 and the L4 port number of the interface 1 of the control protocol processing device 30 are 179. This means that the route control message is transmitted and received between the client side router 12 and the interface 1 of the control protocol processing device 30 using the port number 179 in a L4 protocol, such as a TCP. Moreover, as indicated in the second to fourth entries 46 to 48 in FIG. 4, wildcards may be used to the items of the MAC address 52 of the client side router, the IP address 53 of the client side router, the L4 port number 54 of the client side router, the MAC address 57 of the interface of the control protocol processing device 30, the IP address 58 of the interface of the control protocol processing device 30, and the L4 port number 59 of the interface of the control protocol processing device 30.

The transfer-path-for-control calculation unit 34 calculates, based on the topology DB, the path between the switches indicated by the interface correspondence DB. For example, the transfer-path-for-control calculation unit 34 calculates the path between the switch whose ID is “0x22” and the switch whose ID is “0x21” in the case of the entry 45 illustrated in FIG. 4. The transfer-path-for-control calculation unit 34 transmits the calculated path to the transfer-rule-for-control generation unit 33.

The transfer-rule-for-control generation unit 33 generates, for each switch on the path calculated by the transfer-path-for-control calculation unit 34, the transfer rule for control to transfer the route control message to the next node along the path. The transfer-rule-for-control generation unit 33 transmits the generated transfer rule for control to the transfer rule transmission unit 32.

Furthermore, the transfer-rule-for-data generation unit 37 generates, for each switch on the route indicated by the route information collected by the control protocol processing device 30, the transfer rule for data to transfer the packet to the next node along the route. The transfer-rule-for-data generation unit 37 transmits the generated transfer rule for data to the transfer rule transmission unit 32. Moreover, the transfer-rule-for-data generation unit 37 determines the priority with respect to the transfer rule for data to be generated. A high priority means that the priority of the packet to be referred by the switch when the switch receives the packet is high.

The priority adjustment unit 38 checks the priority to be determined with respect to the transfer rule for data by the transfer-rule-for-data generation unit 37. Then, the priority adjustment unit 38 notifies the transfer rule transmission unit 32 of a priority higher than the priority determined with respect to the transfer rule for data by the transfer-rule-for-data generation unit 37. For example, it is assumed that the priority determined with respect to the transfer rule for data by the transfer-rule-for-data generation unit 37 is a range of 10000 to 12000. In this case, the priority adjustment unit 38 notifies the transfer rule transmission unit 32 of the priority higher than the priority range (for example, 15000).

The transfer rule transmission unit 32 transmits the transfer rule for control generated by the transfer-rule-for-control generation unit 33 to the switch corresponding to the transfer rule for control. At this time, the transfer rule transmission unit 32 transmits, to the switch, the priority notified by the priority adjustment unit 38 together with the transfer rule for control. Furthermore, the transfer rule transmission unit 32 transmits the transfer rule for data generated by the transfer-rule-for-data generation unit 37 and the priority thereof to the switch corresponding to the transfer rule for data.

The transfer-path-for-control calculation unit 34, the transfer-rule-for-control generation unit 33, the transfer-rule-for-data generation unit 37, the priority adjustment unit 38, and the transfer rule transmission unit 32 are implemented by, for example, a CPU of a computer which operates according to a program for a control device. In this case, for example, the CPU reads the program for the control device stored in a program storage device (not illustrated) and may operate, according to the program for the control device, as the transfer-path-for-control calculation unit 34, the transfer-rule-for-control generation unit 33, the transfer-rule-for-data generation unit 37, the priority adjustment unit 38, and the transfer rule transmission unit 32. Furthermore, the transfer-path-for-control calculation unit 34, the transfer-rule-for-control generation unit 33, the transfer-rule-for-data generation unit 37, the priority adjustment unit 38, and the transfer rule transmission unit 32 may be implemented by independent hardware.

Next, operations will be described.

FIGS. 5 and 6 are flowcharts illustrating an example of processing progress when the control device 31 sets the transfer rule for control to a switch. Hereinafter, a switch is referred to as a switch “0x22” or the like using an ID.

First, the transfer-path-for-control calculation unit 34 selects one unprocessed entry from the interface correspondence DB (step S1).

Next, the transfer-path-for-control calculation unit 34 calculates, based on the connection information included in the topology DB (connection information between switches), a path in which a switch to be connected to a client side router in the selected entry is set as a start point and a switch to be connected to the control protocol processing device 30 is set as an end point (step S2). The transfer-path-for-control calculation unit 34 calculates the path by, for example, the Dijkstra method which is an algorithm to calculate the shortest path. However, the Dijkstra method is an example, and the transfer-path-for-control calculation unit 34 may calculates the path by other methods. For example, it is assumed that the entry selected in step S1 is the entry 45 in FIG. 4. In this case, a switch to be connected to the client side router is the switch “0x22”, and the switch is set as a start point. Furthermore, a switch to be connected to the control protocol processing device 30 is the switch “0x21”, the switch is set as an end point. When the path is calculated by the Dijkstra method, the path from the start point to the end point is the path of the switch “0x22”→the switch “0x21” (see FIG. 1). When, for example, the entry 46 in FIG. 4 is selected in step S1, the path from the start point to the end point is calculated as the path of the switch “0x24”→the switch “0x22”→the switch “0x21” (see FIG. 1).

Furthermore, the transfer-path-for-control calculation unit 34 also calculates the path in which the start point and the end point are reversed in step S2. In other words, the transfer-path-for-control calculation unit 34 also calculates the path in which a switch to be connected to the control protocol processing device 30 is set as a start point and a switch to be connected to the client side router is set as an end point. For example, when the transfer-path-for-control calculation unit 34 selects the entry 45 (see FIG. 4) and calculates the path of the switch “0x22”→the switch “0x21” as described above, the transfer-path-for-control calculation unit 34 also calculates the path of the switch “0x21”→the switch “0x22” which is the reversed direction. That is, the transfer-path-for-control calculation unit 34 calculates two paths opposite to each other in step S2.

Moreover, when deriving two paths opposite to each other, the transfer-path-for-control calculation unit 34 may not calculate both by the Dijkstra method. For example, after a path in which a switch to be connected to a client side router is set as a start point and a switch to be connected to the control protocol processing device 30 is set as an end point is calculated by the Dijkstra method, the path in which the start point and the end point are reversed may be derived by reversely arranging the switches on the path.

The transfer-path-for-control calculation unit 34 transmits the information indicating two paths calculated in step S2 together with the entry selected in step Si to the transfer-rule-for-control generation unit 33 (step S3).

Next, the transfer-rule-for-control generation unit 33 selects one switch, to which following processing (specifically, steps S5 and S6) has not been performed, among the switches on two paths transmitted from the transfer-path-for-control calculation unit 34 (step S4). Note that, the transfer-rule-for-control generation unit 33 selects the individual switches on the two paths opposite to each other. For example, the switch “0x22” on the path of the switch “0x24”→the switch “0x22”→the switch “0x21” and the switch “0x22” on the reversed path of the switch “0x21”→the switch “0x22”→the switch “0x24” are individually selected.

Next, the transfer-rule-for-control generation unit 33 generates, based on the entry selected in step S1, a rule used to collate the packet in the flow entry (here, the transfer rule for control) (step S5). For example, it is assumed that the entry selected in step S1 is the entry 45 in FIG. 4. In this case, the transfer-rule-for-control generation unit 33 designates the MAC address “xx:xx:xx:xx:xx:01” of the client side router as the transmission source MAC address in the rule. Similarly, the transfer-rule-for-control generation unit 33 designates the IP address “192.168.0.1” of the client side router as the transmission source IP address in the rule. The transfer-rule-for-control generation unit 33 also designates the L4 port number “179” of the client side router as the transmission source TCP port number in the rule. The transfer-rule-for-control generation unit 33 designates the MAC address “xx: xx:xx:xx:xx:02” of the interface of the control protocol processing device 30 as the destination MAC address in the rule. The transfer-rule-for-control generation unit 33 designates the IP address “192.168.0.2” of the interface of the control protocol processing device 30 as the destination IP address in the rule. Furthermore, the transfer-rule-for-control generation unit 33 designates the L4 port number of the interface of the control protocol processing device 30 as the destination TCP port number in the rule.

Next, the transfer-rule-for-control generation unit 33 completes a flow entry (here, the transfer rule for control) by assigning, to the rule generated in step S5, an action to transfer a packet (here, the route control message) to the next node along the path. Then, the transfer-rule-for-control generation unit 33 transmits the flow entry to the transfer rule transmission unit 32 (step S6).

The processing in step S6 will be exemplified in the case where the switch “0x22” on the path of the switch “0x21”→the switch “0x22”→the switch “0x24” is selected in step S4. The next node of the switch “0x22” is the switch “0x24”, and the port used to transfer the packet to the switch “0x24” at the switch “0x22” is the fourth port (see FIG. 1). Thus, the transfer-rule-for-control generation unit 33 determines the action to transmit the packet from the fourth port.

After step S6, the transfer-rule-for-control generation unit 33 determines whether or not the processing in steps S5 and S6 to all of the switches on the two paths transmitted from the transfer-path-for-control calculation unit 34 in step S3 has been completed (step S7). When there is a switch to which the processing in steps S5 and S6 has not been completed (No in step S7), the transfer-rule-for-control generation unit 33 repeats the processing after step S4.

By repeating the processing in steps S4 to S7, it is possible to obtain the transfer rule for control to transfer the route control message to the next node along the path for each switch on the two paths opposite to each other calculated in step S2.

Furthermore, the transfer rule transmission unit 32 is notified of the priority by the priority adjustment unit 38 (step S8). In other words, the priority adjustment unit 38 notifies the transfer rule transmission unit 32 of the priority higher than the priority determined by the transfer-rule-for-data generation unit 37 with respect to the transfer rule for data. Then, the transfer rule transmission unit 32 receives the priority.

The transfer rule transmission unit 32 transmits the transfer rule for control generated by the transfer-rule-for-control generation unit 33 and the priority notified by the priority adjustment unit 38 to the switch corresponding to the transfer rule for control (step S9). The transfer rule transmission unit 32 transmits the transfer rule for control to each switch using the OpenFlow protocol. Each switch holds the transfer rule for control received from the transfer rule transmission unit 32 as a flow entry. In other words, the transfer rule transmission unit 32 sets the transfer rule for control to a switch by transmitting the transfer rule for control to the switch.

After step S9, the transfer-path-for-control calculation unit 34 determines whether or not all of the entries in the interface correspondence DB have been selected (step S10). When there is an unselected entry in the interface correspondence DB (No in step S10), the processing moves to step S1, and the processing after step S1 is repeated. When all of the entries in the interface correspondence DB have been selected (Yes in step S10), the processing is terminated.

By setting the transfer rule for control to each switch, it is possible to transmit and receive the route control message between the individual client side routers 12 to 15 and the control protocol processing device 30. Then, the client side routers 12 to 15 and the control protocol processing device 30 transmit and receive the route control message via the switch in the control target network 40, and the control protocol processing device 30 collects the route information held by the client side routers 12 to 15 in advance accordingly.

The control protocol processing device 30 transmits, to the control device 31, the route information collected from the individual client side routers 12 to 15. Then, the transfer-rule-for-data generation unit 37 in the control device 31 acquires the route information. The transfer-rule-for-data generation unit 37 identifies, based on the route information, the route used when the packet corresponding to the data is transmitted and received between the client side routers, and generates the transfer rule for data to transfer the packet to the next node for each switch in the route information. At this time, the transfer-rule-for-data generation unit 37 also determines the priority of the transfer rule for data. The transfer-rule-for-data generation unit 37 transmits the transfer rule for data generated for each switch on the route and the priority thereof to the transfer rule transmission unit 32. The transfer rule transmission unit 32 transmits the transfer rule for data and the priority thereof to the switch corresponding to the transfer rule for data. Each switch holds the transfer rule for data received from the transfer rule transmission unit 32 as the flow entry. In other words, the transfer rule transmission unit 32 sets the transfer rule for data to a switch by transmitting the transfer rule for data to the switch. Then, by setting the transfer rule for data for each switch, it is possible to transmit and receive the packet corresponding to the data between the client side routers 12 to 15.

According to the present exemplary embodiment, the control device 31 determines the path used when the client side routers 12 to 15 and the control protocol processing device 30 transmit and receive the route control message, and also determines the transfer rule for control for each switch on the path. Then, the control device 31 sets the transfer rule for control to the switch by transmitting the transfer rule for control to the switch on the path. Thus, the route control message is exchanged between the individual client side routers 12 to 15 and the control protocol processing device 30 via the switch in the control target network 40. Accordingly, it is possible to prevent the processing load on the control device 31 from increasing without relaying the route control message by the control device 31.

Furthermore, the present invention is compared with the technique disclosed in Patent Literature 1. In the technique disclosed in Patent Literature 1, the relay device is required to add a symbol to a packet when transmitting the packet to the control device. In contrast, in the present invention, the control protocol processing device 30 can transmit, to the control device 31, the route information collected from the client side routers 12 to 15 without adding such a symbol. Thus, it is possible to prevent the data length of the route information from becoming longer and prevent the processing load on the route information from increasing in the process where the transfer-rule-for-data generation unit 37 in the control device 31 acquires the route information.

Furthermore, in the present exemplary embodiment, the priority of the transfer rule for control used to transfer the route control message is higher than the priority of the transfer rule for data used to transfer the packet to be exchanged between the client side routers. Thus, it is possible to transmit only the route control message among the traffics of the client side routers 12 to 15 to the control protocol processing device 30, and transmit the other packets to the other client side routers.

### Second Exemplary Embodiment

A configuration example of a network system in a second exemplary embodiment can be illustrated similarly to FIG. 1 and will be described with reference to FIG. 1. However, a part of a configuration of a control device 31 in the second exemplary embodiment is different from the configuration of the control device 31 in the first exemplary embodiment.

In the second exemplary embodiment, when receiving a route control message which does not match any flow entry, a switch transmits the route control message to the control device 31 by transmitting a Packet-in message to the control device 31. When acquiring the route control message by the Packet-in message, the control device 31 determines a path to transfer the route control message from a transmission source to a destination. Then, the control device 31 determines a transfer rule for control for each switch on the path and sets the transfer rule for control for each switch. In other words, in the second exemplary embodiment, when the control device 31 acquires a route control message corresponding to a first packet, the control device 31 determines a path to transfer the route control message from a transmission source to a destination and sets the transfer rule for control for each switch on the path.

FIG. 7 is a block diagram illustrating a configuration example of the control device in the second exemplary embodiment of the present invention. The control device 31 in the present exemplary embodiment includes a Packet-in reception unit 81 and a packet type determination unit 82 in addition to the elements included in the control device 31 in the first exemplary embodiment. Furthermore, in the present exemplary embodiment, a part of an interface correspondence DB stored in an interface correspondence DB storage unit 36 is different from the interface correspondence DB in the first exemplary embodiment. A part of operations of a transfer-path-for-control calculation unit 34, a transfer-rule-for-control generation unit 33, and a priority adjustment unit 38 are also different from the operations of the corresponding elements in the first exemplary embodiment. Moreover, a topology DB storage unit 35, a transfer-rule-for-data generation unit 37 and a transfer rule transmission unit 32 are similar to the corresponding elements in the first exemplary embodiment, and the descriptions thereof will be omitted.

When receiving a packet which does not match any flow entry (that is, a first packet), a switch includes the packet in the Packet-in message in the OpenFlow protocol. The switch also includes the ID of the switch in the Packet-in message as information on the transmission source of the Packet-in message. The switch further includes the port number which has received the first packet in the Packet-in message. Then, the switch transmits the Packet-in message to the control device 31 via the secure channel.

The Packet-in reception unit 81 receives the above Packet-in message via the secure channel Then, the Packet-in reception unit 81 extracts the packet from the Packet-in message. The Packet-in reception unit 81 also extracts, from the Packet-in message, the ID of the transmission source switch of the Packet-in message (that is, the ID of the switch which has received the first packet) and the port number of the switch which has received the first packet. Then, the Packet-in reception unit 81 collectively transmits the packet, the switch ID, and the port number which are extracted from the Packet-in message to the packet type determination unit 82.

The packet type determination unit 82 analyzes the packet acquired from the Packet-in reception unit 81 and determines whether or not the packet is a route control message. When the packet is a route control message, the packet type determination unit 82 transmits, to the transfer-path-for-control calculation unit 34, the packet (the route control message), and the ID and the port number of the switch acquired from the Packet-in reception unit 81.

On the other hand, when the packet acquired from the Packet-in reception unit 81 is not a route control message, the packet type determination unit 82 terminates the processing without transmitting the packet to the transfer-path-for-control calculation unit 34.

The interface correspondence DB storage unit 36 stores an interface correspondence DB. However, the interface correspondence DB in the second exemplary embodiment is different from the interface correspondence DB in the first exemplary embodiment. FIG. 8 is an explanatory diagram illustrating an example of the interface correspondence DB in the second exemplary embodiment. In the present exemplary embodiment, entries included in the interface correspondence DB are only required to include an ID 50 of a switch to be connected to a client side router, a port number 51 of a port to be connected to the client side router at the switch, an ID 55 of a switch to be connected to the control protocol processing device 30, and a port number 56 of a port to be connected to the control protocol processing device 30 at the switch. Note that, the individual entries 45a to 48a each correspond to one client side router. This is similar to the first exemplary embodiment.

The transfer-path-for-control calculation unit 34 is different from that in the first exemplary embodiment, and generates a path when the packet (the route control message), the switch ID, and the port number are transmitted from the packet type determination unit 82.

The transfer-rule-for-control generation unit 33 generates a transfer rule for control using the packet (the route control message).

The priority adjustment unit 38 in the second exemplary embodiment checks the priority determined by the transfer-rule-for-data generation unit 37 with respect to the transfer rule for data. Then, the priority adjustment unit 38 notifies the transfer rule transmission unit 32 of the priority lower than the priority determined by the transfer-rule-for-data generation unit 37 with respect to the transfer rule for data.

The transfer-path-for-control calculation unit 34, the transfer-rule-for-control generation unit 33, the transfer-rule-for-data generation unit 37, the priority adjustment unit 38, the transfer rule transmission unit 32, the Packet-in reception unit 81 and the packet type determination unit 82 are implemented by a CPU of a computer which operates according to, for example, a program for a control device. In this case, for example, the CPU reads the program for the control device stored in a program storage device (not illustrated) and may operate, according to the program for the control device, as the transfer-path-for-control calculation unit 34, the transfer-rule-for-control generation unit 33, the transfer-rule-for-data generation unit 37, the priority adjustment unit 38, the transfer rule transmission unit 32, the Packet-in reception unit 81, and the packet type determination unit 82. Furthermore, these elements may be implemented by independent hardware.

FIGS. 9 and 10 are flowcharts illustrating an example of processing progress when the control device 31 sets the transfer rule for control to a switch in the second exemplary embodiment. As described above, when receiving a Packet-in message via the secure channel, the Packet-in reception unit 81 extracts, from the Packet-in message, the packet, the ID of the transmission source switch of the Packet-in message, and the port number which has received the first packet at the switch, and transmits the extracted information to the packet type determination unit 82.

The packet type determination unit 82 analyzes the packet acquired from the Packet-in reception unit 81 and determines whether or not the packet is a route control message. The packet type determination unit 82 transmits, to the transfer-path-for-control calculation unit 34, the packet, the switch ID, and the port number which are acquired from the Packet-in reception unit 81 on the condition that the packet is a route control message. The above operation is omitted from the flowchart in FIG. 9.

When the packet, the switch ID, and the port number are transmitted from the packet type determination unit 82, the transfer-path-for-control calculation unit 34 starts the processing of step S11. Note that, the packet is the route control message. Furthermore, the switch ID and the port number transmitted from the packet type determination unit 82 are the ID of the switch which has received the route control message corresponding to the first packet and the port number of the port which has received the route control message at the switch.

By using the switch ID and the port number transmitted from the packet type determination unit 82, the transfer-path-for-control calculation unit 34 searches the interface correspondence DB for the switch ID and the port number associated with a pair of the switch ID and the port number (step S11).

An example of step S11 will be described with reference to the interface correspondence DB exemplified in FIG. 8. For example, it is assumed that the switch ID and the port number transmitted from the packet type determination unit 82 are “0x24” and “3” respectively. The pair of the ID “0x24” and the port number “3” is included in the entry 46a (see FIG. 8). Then, in the entry 46a, the ID “0x24” and the port number “3” are the ID and the port number of the switch to be connected to a client side router. Thus, the transfer-path-for-control calculation unit 34 searches the entry 46a for the ID “0x21” and the port number “2” of the switch connected with the control protocol processing device 30 and corresponding to the pair of the ID “0x24” and the port number “3”.

Furthermore, for example, it is assumed that the switch ID and the port number transmitted from the packet type determination unit 82 are “0x21” and “4” respectively. A pair of the ID “0x21” and the port number “4” is included in the entry 48a. Then, in the entry 48a, the ID “0x21” and the port number “4” are the ID and the port number of the switch connected with the control protocol processing device 30. Thus, the transfer-path-for-control calculation unit 34 searches the entry 48a for the ID “0x25” and the port number “2” of the switch to be connected to a client side router and corresponding to the pair of the ID “0x21” and the port number “4”.

After step S11, the transfer-path-for-control calculation unit 34 calculates, based on the connection information included in the topology DB (connection information between switches), a path in which the switch identified by the ID transmitted from the packet type determination unit 82 is set as a start point and the switch identified by the ID acquired by the search in step S11 is set as an end point (step S12). The transfer-path-for-control calculation unit 34 only has to calculate the path using, for example, the Dijkstra method. Note that, in the second exemplary embodiment, the path in which the start point and the end point are reversed does not need to be calculated.

Next, the transfer-path-for-control calculation unit 34 transmits, to the transfer-rule-for-control generation unit 33, the information indicating the path calculated in step S12 together with the packet (the route control message corresponding to the first packet), the switch ID, and the port number which are transmitted from the packet type determination unit 82 (step S13).

Next, the transfer-rule-for-control generation unit 33 selects a switch, to which the following processing (specifically, steps S15 and S16) has not been performed, among the switches on the path transmitted from the transfer-path-for-control calculation unit 34 (step S14).

Next, the transfer-rule-for-control generation unit 33 generates, based on the packet transmitted from the packet type determination unit 82 (the route control message corresponding to the first packet), a rule used to collate the packet in the flow entry (the transfer rule for control) (step S15). Specifically, the transfer-rule-for-control generation unit 33 extracts, from the packet, the transmission source MAC address, the destination MAC address, the transmission source IP address, the destination IP address, the protocol number, the transmission source port number, and the destination port number, and determines the condition to satisfy them as a rule. Here, seven items are exemplified as the items included in the rule. The transfer-rule-for-control generation unit 33 may use a wildcard to a part of these items. For example, the transmission source port number and the destination port number each are “179”, the transfer-rule-for-control generation unit 33 may use a wildcard to the port number in the rule.

Next, the transfer-rule-for-control generation unit 33 completes the flow entry (here, the transfer rule for control) by assigning, to the rule generated in step S15, an action to transfer the packet (here, the route control message) to the next node along the path. Then, the transfer-rule-for-control generation unit 33 transmits the flow entry to the transfer rule transmission unit 32 (step S16). The operation of step S16 is similar to the operation of step S6 in the first exemplary embodiment.

After step S16, the transfer-rule-for-control generation unit 33 determines whether or not the processing of steps S15 and S16 has been performed to all of the switches on the path transmitted from the transfer-path-for-control calculation unit 34 in step S13 (step S17). When there is a switch to which the processing of steps S15 and S16 has not been performed (No in step S17), the transfer-rule-for-control generation unit 33 repeats the processing after step S14.

By repeating the processing from step S14 to S17, it is possible to acquire the transfer rule for control to transfer the route control message to the next node along the path for each switch on the path calculated in step S12.

Furthermore, the transfer rule transmission unit 32 is notified of the priority by the priority adjustment unit 38 (step S18). In other words, the priority adjustment unit 38 notifies the transfer rule transmission unit 32 of the priority lower than the priority determined by the transfer-rule-for-data generation unit 37 with respect to the transfer rule for data. Then, the transfer rule transmission unit 32 receives the priority.

The transfer rule transmission unit 32 transmits, to the switch corresponding to the transfer rule for control, the transfer rule for control generated by the transfer-rule-for-control generation unit 33 and the priority notified by the priority adjustment unit 38 (step S19). The transfer rule transmission unit 32 transmits the transfer rule for control to each switch using the OpenFlow protocol. Each switch holds the transfer rule for control received from the transfer rule transmission unit 32 as the flow entry. In other words, the transfer rule transmission unit 32 sets the transfer rule for control to the switch by transmitting the transfer rule for control to the switch.

The transfer rule for control is set to each switch on the path calculated in step S12, and the route control message corresponding to the first packet is sequentially transferred to the destination accordingly. Furthermore, the route control message in which the transmission source and destination is the same as the transmission source and destination of the route control message corresponding to the first packet is sequentially transferred to the destination.

Then, in the present exemplary embodiment, every time the route control message corresponding to the first packet is detected, the transfer rule for control to transfer the route control message is generated and set to the switch.

As described above, when the route control message to be exchanged between the client side routers 12 to 15 and the control protocol processing device 30 has been detected as the first packet, the path is calculated by the control device 31, and the transfer rule for control is set to the switch on the path. Thus, the client side routers 12 to 15 and the control protocol processing device 30 can transmit and receive the route control message via the switch in the control target network 40. As a result, the control protocol processing device 30 can collect the route information held by the client side routers 12 to 15 in advance.

The control protocol processing device 30 transmits the route information collected from the client side routers 12 to 15 to the control device 31. The following operation is similar to the operation which has been described in the first exemplary embodiment, and the description thereof will be omitted.

According to the present exemplary embodiment, the control device 31 determines the path used when the client side routers 12 to 15 and the control protocol processing device 30 transmits and receive the route control message, and determines the transfer rule for control for each switch on the path. Then, the control device 31 sets the transfer rule for control to the switch by transmitting the transfer rule for control to the switch on the path. Thus, the control device 31 does not need to relay the route control message similarly to the first exemplary embodiment, and it is possible to prevent the processing load on the control device 31 from increasing.

Furthermore, similarly to the first exemplary embodiment, it is possible to prevent the data length of the route information from becoming long, and the processing load on the route information from occurring in the process where the transfer-rule-for-data generation unit 37 in the control device 31 acquires the route information.

Moreover, in the present exemplary embodiment, the priority of the transfer rule for control used to transfer the route control message is lower than the priority of the transfer rule for data used to transfer the packet to be exchanged between the client side routers. Thus, in the present exemplary embodiment, when the transfer rule matching the packet received by the switch is searched for, the transfer rule for data is preferentially searched for. As a result, it is possible to collate the transfer rule for control only with the packet which does not match any transfer rule for data.

Next, the outline of the present invention will be described. FIG. 11 is a block diagram illustrating the outline of the control device of the present invention. FIG. 12 is a block diagram illustrating the outline of the network system of the present invention. The network system of the present invention includes a plurality of transfer devices 93 which transfer a packet (for example, the switches 21 to 25), and a control device 90 which controls the packet transferring operation of the transfer device 93 (for example, the control device 31). Then, the control device 90 includes transfer-rule-for-control generation means 91 (see FIGS. 11 and 12).

The transfer-rule-for-control generation means 91 (for example, the transfer-rule-for-control generation unit 33) generates a transfer rule for control which defines the operation for a transfer device to transfer, between a router and a route information collection device, a control message (for example, the route control message) to notify a route information collection device (for example, the control protocol processing device 30) of route information indicating a route used when routers (for example, the client side routers 12 to 15) transmit a packet to the other routers via the transfer device.

With such a configuration, it is possible to transmit a control message to a device provided separately from a control device without increasing the load on the control device 90.

A part of or all of the above exemplary embodiments can be described as, but not limited to, the following supplementary notes.

(Supplementary note 1) A control device which controls a packet transferring operation of a plurality of transfer devices to transfer a packet, the control device including: transfer-rule-for-control generation means for generating a transfer rule for control which defines an operation for the transfer device to transfer, between a router and a route information collection device, a control message to notify the route information collection device of route information indicating a route used when the router transmits the packet to another router via the transfer device.

(Supplementary note 2) The control device according to Supplementary note 1, including: path calculation means for calculating a path between the transfer device to be connected to the router and the transfer device to be connected to an interface of the route information collection device, wherein the transfer-rule-for-control generation means generates the transfer rule for control to transfer the control message to a next node along the path for each transfer device on the path.

(Supplementary note 3) The control device according to Supplementary note 1 or 2, including: transfer-rule-for-data generation means for generating a transfer rule for data which defines an operation for the transfer device to transfer, between the routers, the packet to be transmitted and received between the routers; and priority adjustment means for setting a priority for a switch to refer to the transfer rule for control to a value different from a priority for the switch to refer to the transfer rule for data.

(Supplementary note 4) The control device according to Supplementary note 2, including: transfer-rule-for-data generation means for generating a transfer rule for data which defines an operation for the transfer device to transfer, between the routers, the packet to be transmitted and received between the routers; and priority adjustment means for setting a priority for a switch to refer to the transfer rule for control to a value higher than a priority for the switch to refer to the transfer rule for data, wherein the path calculation means calculates, based on information indicating correspondence relation between the interface of the route information collection device to be connected to the transfer device and the router, the path between the transfer device to be connected to the router and the transfer device to be connected to the interface of the route information collection device.

(Supplementary note 5) The control device according to Supplementary note 2, including: transfer-rule-for-data generation means for generating a transfer rule for data which defines an operation for the transfer device to transfer, between the routers, the packet to be transmitted and received between the routers; and priority adjustment means for setting a priority for a switch to refer to the transfer rule for control to a value lower than a priority for the switch to refer to the transfer rule for data, wherein when receiving from the switch the control message indicating that the switch has determined that the packet does not match the transfer rule for control, the path calculation means calculates, based on the control message, a path between the transfer device to be connected to the router and the transfer device to be connected to the interface of the route information collection device.

(Supplementary note 6) The control device according to any one of Supplementary notes 1 to 5, wherein the transfer-rule-for-control generation means generates the transfer rule for control in which an address of the route information collection device is determined as a condition for the control message to match the transfer rule for control.

(Supplementary note 7) The control device according to any one of Supplementary notes 1 to 6, wherein the transfer-rule-for-control generation means generates the transfer rule for control in which an address of the router is determined as a condition for the control message to match the transfer rule for control.

(Supplementary note 8) A network system including: a plurality of transfer devices configured to transfer a packet; and a control device configured to control a packet transferring operation of the transfer devices, wherein the control device includes transfer-rule-for-control generation means for generating a transfer rule for control which defines an operation for the transfer device to transfer, between a router and a route information collection device, a control message to notify the route information collection device of route information indicating a route used when the router transmits the packet to another router via the transfer device.

(Supplementary note 9) A packet transfer control method including: generating, by a control device which controls a packet transferring operation of a plurality of transfer devices to transfer a packet, a transfer rule for control which defines an operation for the transfer device to transfer, between a router and a route information collection device, a control message to notify the route information collection device of route information indicating a route used when the router transmits the packet to another router via the transfer device.

(Supplementary note 10) The packet transfer control method according to Supplementary note 9, including: calculating, by the control device, a path between the transfer device to be connected to the router and the transfer device to be connected to an interface of the route information collection device; and generating, by the control device, the transfer rule for control to transfer the control message to a next node along the path for each transfer device on the path.

(Supplementary note 11) The packet transfer control method according to Supplementary note 9 or 10, including: generating, by the control device, a transfer rule for data which defines an operation for the transfer device to transfer, between the routers, the packet to be transmitted and received between the routers; and setting, by the control device, a priority for a switch to refer to the transfer rule for control to a value different from a priority for the switch to refer to the transfer rule for data.

(Supplementary note 12) The packet transfer control method according to any one of Supplementary notes 9 to 11, including: calculating, by the control device, based on information indicating correspondence relation between the interface of the route information collection device to be connected to the transfer device and the router, the path between the transfer device to be connected to the router and the transfer device to be connected to the interface of the route information collection device; generating, by the control device, the transfer rule for data which defines an operation for the transfer device to transfer, between the routers, the packet to be transmitted and received between the routers; and setting, by the control device, a priority for the switch to refer to the transfer rule for control to a value higher than a priority for the switch to refer to the transfer rule for data.

(Supplementary note 13) The packet transfer control method according to any one of Supplementary notes 9 to 11, including: when receiving from the switch the control message indicating that the switch has determined that the packet does not match the transfer rule for control, calculating, by the control device, based on the control message, the path between the transfer device to be connected to the router and the transfer device to be connected to the interface of the route information collection device; generating, by the control device, the transfer rule for data which defines an operation for the transfer device to transfer, between the routers, the packet to be transmitted and received between the routers; and setting, by the control device, a priority for the switch to refer to the transfer rule for control to a value lower than a priority for the switch to refer to the transfer rule for data.

(Supplementary note 14) The packet transfer control method according to any one of Supplementary notes 9 to 13, including generating, by the control device, the transfer rule for control in which an address of the route information collection device is determined as a condition for the control message to match the transfer rule for control.

(Supplementary note 15) The packet transfer control method according to any one of Supplementary notes 9 to 14, including generating, by the control device, the transfer rule for control in which an address of the router is determined as a condition for the control message to match the transfer rule for control.

(Supplementary note 16) A program for a control device to be installed to a computer which controls a packet transferring operation of a plurality of transfer devices to transfer a packet, the program causes the computer to execute: transfer-rule-for-control generation processing to generate a transfer rule for control which defines an operation for the transfer device to transfer, between a router and a route information collection device, a control message to notify the route information collection device of route information indicating a route used when the router transmits the packet to another router via the transfer device.

As described above, the present invention has been described with reference to the exemplary embodiments, but is not limited to the above exemplary embodiments. Various modifications, which can be understood by a person in the art, can be made in the configuration and the details within the scope of the present invention.

This application claims priority based on Japanese Patent Application No. 2013-199255 filed on Sep. 26, 2013, and the disclosure of which is hereby incorporated in its entirety.

### INDUSTRIAL APPLICABILITY

The present invention is suitably applied to a network system using the OpenFlow.

### REFERENCE SIGNS LIST

12 to 15 client side router
21 to 25 switch
30 control protocol processing device
31 control device
32 transfer rule transmission unit
33 transfer-rule-for-control generation unit
34 transfer-path-for-control calculation unit
35 topology DB storage unit
36 interface correspondence DB storage unit
37 transfer-rule-for-data generation unit
38 priority adjustment unit
81 packet-in reception unit
82 packet type determination unit

1. A control device which controls a packet transferring operation of a plurality of transfer devices to transfer a packet, the control device comprising:
a transfer-rule-for-control generation unit for generating a transfer rule for control which defines an operation for the transfer device to transfer, between a router and a route information collection device, a control message to notify the route information collection device of route information indicating a route used when the router transmits the packet to another router via the transfer device.

2. The control device according to claim 1, comprising:
a path calculation unit for calculating a path between the transfer device to be connected to the router and the transfer device to be connected to an interface of the route information collection device, wherein
the transfer-rule-for-control generation unit generates the transfer rule for control to transfer the control message to a next node along the path for each transfer device on the path.

3. The control device according to claim 1, comprising:
a transfer-rule-for-data generation unit for generating a transfer rule for data which defines an operation for the transfer device to transfer, between the routers, the packet to be transmitted and received between the routers; and
a priority adjustment unit for setting a priority for a switch to refer to the transfer rule for control to a value different from a priority for the switch to refer to the transfer rule for data.

4. The control device according to claim 2, comprising:
a transfer-rule-for-data generation unit for generating a transfer rule for data which defines an operation for the transfer device to transfer, between the routers, the packet to be transmitted and received between the routers; and
a priority adjustment unit for setting a priority for a switch to refer to the transfer rule for control to a value higher than a priority for the switch to refer to the transfer rule for data, wherein
the path calculation unit calculates, based on information indicating correspondence relation between the interface of the route information collection device to be connected to the transfer device and the router, the path between the transfer device to be connected to the router and the transfer device to be connected to the interface of the route information collection device.

5. The control device according to claim 2, comprising:
a transfer-rule-for-data generation unit for generating a transfer rule for data which defines an operation for the transfer device to transfer, between the routers, the packet to be transmitted and received between the routers; and
a priority adjustment unit for setting a priority for a switch to refer to the transfer rule for control to a value lower than a priority for the switch to refer to the transfer rule for data, wherein
when receiving from the switch the control message indicating that the switch has determined that the packet does not match the transfer rule for control, the path calculation unit calculates, based on the control message, a path between the transfer device to be connected to the router and the transfer device to be connected to the interface of the route information collection device.

6. The control device according to claim 1, wherein the transfer-rule-for-control generation unit generates the transfer rule for control in which an address of the route information collection device is determined as a condition for the control message to match the transfer rule for control.

7. The control device according to claim 1, wherein the transfer-rule-for-control generation unit generates the transfer rule for control in which an address of the router is determined as a condition for the control message to match the transfer rule for control.

8. A network system comprising:
a plurality of transfer devices configured to transfer a packet; and
a control device configured to control a packet transferring operation of the transfer devices, wherein
the control device comprises a transfer-rule-for-control generation unit for generating a transfer rule for control which defines an operation for the transfer device to transfer, between a router and a route information collection device, a control message to notify the route information collection device of route information indicating a route used when the router transmits the packet to another router via the transfer device.

9. A packet transfer control method comprising:
generating, by a control device which controls a packet transferring operation of a plurality of transfer devices to transfer a packet, a transfer rule for control which defines an operation for the transfer device to transfer, between a router and a route information collection device, a control message to notify the route information collection device of route information indicating a route used when the router transmits the packet to another router via the transfer device.

10. The packet transfer control method according to claim 9, comprising:
calculating, by the control device, a path between the transfer device to be connected to the router and the transfer device to be connected to an interface of the route information collection device; and
generating, by the control device, the transfer rule for control to transfer the control message to a next node along the path for each transfer device on the path.

11. The packet transfer control method according to claim 9, comprising:
generating, by the control device, a transfer rule for data which defines an operation for the transfer device to transfer, between the routers, the packet to be transmitted and received between the routers; and
setting, by the control device, a priority for a switch to refer to the transfer rule for control to a value different from a priority for the switch to refer to the transfer rule for data.

12. The packet transfer control method according to claim 9, comprising:
calculating, by the control device, based on information indicating correspondence relation between the interface of the route information collection device to be connected to the transfer device and the router, the path between the transfer device to be connected to the router and the transfer device to be connected to the interface of the route information collection device;
generating, by the control device, the transfer rule for data which defines an operation for the transfer device to transfer, between the routers, the packet to be transmitted and received between the routers; and
setting, by the control device, a priority for the switch to refer to the transfer rule for control to a value higher than a priority for the switch to refer to the transfer rule for data.

13. The packet transfer control method according to claim 9, comprising:
when receiving from the switch the control message indicating that the switch has determined that the packet does not match the transfer rule for control, calculating, by the control device, based on the control message, the path between the transfer device to be connected to the router and the transfer device to be connected to the interface of the route information collection device;
generating, by the control device, the transfer rule for data which defines an operation for the transfer device to transfer, between the routers, the packet to be transmitted and received between the routers; and
setting, by the control device, a priority for the switch to refer to the transfer rule for control to a value lower than a priority for the switch to refer to the transfer rule for data.

14. The packet transfer control method according to claim 9, comprising generating, by the control device, the transfer rule for control in which an address of the route information collection device is determined as a condition for the control message to match the transfer rule for control.

15. The packet transfer control method according to claim 9, comprising generating, by the control device, the transfer rule for control in which an address of the router is determined as a condition for the control message to match the transfer rule for control.

16. (canceled)

17. The packet transfer control method according to claim 10, comprising:
generating, by the control device, a transfer rule for data which defines an operation for the transfer device to transfer, between the routers, the packet to be transmitted and received between the routers; and
setting, by the control device, a priority for a switch to refer to the transfer rule for control to a value different from a priority for the switch to refer to the transfer rule for data.

18. The packet transfer control method according to claim 10, comprising:
calculating, by the control device, based on information indicating correspondence relation between the interface of the route information collection device to be connected to the transfer device and the router, the path between the transfer device to be connected to the router and the transfer device to be connected to the interface of the route information collection device;
generating, by the control device, the transfer rule for data which defines an operation for the transfer device to transfer, between the routers, the packet to be transmitted and received between the routers; and
setting, by the control device, a priority for the switch to refer to the transfer rule for control to a value higher than a priority for the switch to refer to the transfer rule for data.

19. The packet transfer control method according to claim 11, comprising:
calculating, by the control device, based on information indicating correspondence relation between the interface of the route information collection device to be connected to the transfer device and the router, the path between the transfer device to be connected to the router and the transfer device to be connected to the interface of the route information collection device;
generating, by the control device, the transfer rule for data which defines an operation for the transfer device to transfer, between the routers, the packet to be transmitted and received between the routers; and
setting, by the control device, a priority for the switch to refer to the transfer rule for control to a value higher than a priority for the switch to refer to the transfer rule for data.

20. The packet transfer control method according to claim 10, comprising:
when receiving from the switch the control message indicating that the switch has determined that the packet does not match the transfer rule for control, calculating, by the control device, based on the control message, the path between the transfer device to be connected to the router and the transfer device to be connected to the interface of the route information collection device;
generating, by the control device, the transfer rule for data which defines an operation for the transfer device to transfer, between the routers, the packet to be transmitted and received between the routers; and
setting, by the control device, a priority for the switch to refer to the transfer rule for control to a value lower than a priority for the switch to refer to the transfer rule for data.

21. The packet transfer control method according to claim 11, comprising:
when receiving from the switch the control message indicating that the switch has determined that the packet does not match the transfer rule for control, calculating, by the control device, based on the control message, the path between the transfer device to be connected to the router and the transfer device to be connected to the interface of the route information collection device;
generating, by the control device, the transfer rule for data which defines an operation for the transfer device to transfer, between the routers, the packet to be transmitted and received between the routers; and
setting, by the control device, a priority for the switch to refer to the transfer rule for control to a value lower than a priority for the switch to refer to the transfer rule for data
